(19) United States
(12) Patent Application Publication
(10) Pub. No.: US 2023/0205983 A1
(43) Pub. Date: Jun. 29, 2023

(54) USER-FACING SPREADSHEET PROGRAMMING LANGUAGE

(71) Applicant: Chang Liu, Singapore (SG)

(72) Inventor: Chang Liu, Singapore (SG)

(21) Appl. No.: 17/927,911

(22) PCT Filed: May 31, 2021
(86) PCT No.: PCT/SG2021/050299

§ 371 Date: Nov. 28, 2022

(30) Foreign Application Priority Data
May 29, 2020 (SG) 10202005091R

(51) Int. Cl. G06F 40/18; G06F 8/30

(52) U.S. Cl. CPC G06F 40/18; G06F 8/31

(57) ABSTRACT

Spreadsheets and methods for programming spreadsheets are provided. In accordance with one aspect. The spreadsheet includes a plurality of cells arranged in a two-dimensional array. One or more of the plurality of cells include a plurality of adjoining variable value cells for data corresponding to a plurality of values of a variable. The plurality of adjoining variable value cells are user defined by a pair of cell values indicating a start and an end of a cell range of the plurality of adjoining variable value cells. The plurality of cells also include a spill area into which data can flow from a cell having an expression defined therein in response to the expression including a variable range defined by the plurality of values of the variable. The spill area is automatically sized to a plurality of expression solutions corresponding to the plurality of values of the variable.

### PRIORITY CLAIM

This application claims priority from Singapore Patent Application No. 10202005091R filed on 29 May 2020.

### TECHNICAL FIELD

The present invention generally relates to computer spreadsheet systems, and more particularly relates to methods and systems for a user-facing spreadsheet programming language.

### BACKGROUND OF THE DISCLOSURE

Many current mainstream languages used by professional programmers, such as C, C++, Java, and Python, are based on a linear flow of plain text. A central goal of these languages is to enable application building in a Lego®-like manner where functionalities are not built from scratch, but rather assembled from existing libraries, usually in the form of functions and classes. Different libraries can coexist and cooperate and the programmers' main job is simply to customize and orchestrate these logic blocks. Today's languages have proven to be extremely versatile and have largely attained this goal. Unfortunately, they have also proven to be too abstract to a majority of non-programmers, resulting in a huge gulf between programmers and non-programmers, and leading to non-programmers devolving into mere passive consumers of technology.

On the other side of the chasm are spreadsheets, which is based around a two-dimensional (2D) grid structure rather than plain text. Spreadsheet systems such as Microsoft Excel and Google Sheet are some of the only practically accessible systems where non-programmer users can express non-trivial logic for execution by a computer. However, when viewed as a development environment, spreadsheets lack basic facilities considered essential for mainstream programming languages, such as the ability to re-use code in the form of functions and classes, the ability to unit test, and the ability to import prebuilt third-party spreadsheets. Therefore, spreadsheets in practice are often found with copious amounts of duplicate code and bugs, leading to an environment where spreadsheets quickly become unmanageable as requirements get more complex. Furthermore, there's no upgrade path from a spreadsheet to a more technically sound solution. Users either turn to Visual Basics for Applications (VBA) programmers to build more complex functionalities (where VBA is a conventional plain text-based language) or, very often, simply throw away spreadsheets and completely reimplement the logic in a mainstream language.

Thus, there is a need for a robust user-facing spreadsheet programming language which overcomes the drawbacks of prior spreadsheet enabled programming and provides an easy, flexible and versatile backward-compatible spreadsheet-friendly solution. Furthermore, other desirable features and characteristics will become apparent from the subsequent detailed description and the appended claims, taken in conjunction with the accompanying drawings and this background of the disclosure.

### SUMMARY

According to at least one aspect of the present embodiments, a method for spreadsheet programming is provided. The method includes assigning labels to cells of a spreadsheet, each of the labels assigned to one of a plurality of adjoining variable value cells for data corresponding to a plurality of values of a variable. The plurality of adjoining variable value cells is user defined by a pair of labels indicating a start and an end of a cell range of the plurality of adjoining variable value cells. The method further includes defining a spill area into which data can flow from a cell having an expression defined therein in response to the expression including a variable range defined by the plurality of values of the variable. The spill area is automatically sized to a plurality of expression solutions corresponding to the plurality of values of the variable.

According to another aspect of the present embodiments, an additional method for spreadsheet programming is provided. The method includes substituting another item into a spreadsheet in response to cell values of a cell in the spreadsheet comprising a function call and/or a remote callback.

According to a further aspect of the present embodiments, a spreadsheet is provided. The spreadsheet includes a plurality of cells arranged in a two-dimensional array. One or more of the plurality of cells include cell values for substituting another item into the spreadsheet, the cell values including a function call and/or a remote callback.

According to an additional aspect of the present embodiments, a spreadsheet is provided. The spreadsheet includes a plurality of cells arranged in a two-dimensional array. One or more of the plurality of cells include a plurality of adjoining variable value cells for data corresponding to a plurality of values of a variable. The plurality of adjoining variable value cells is user defined by a pair of cell values indicating a start and an end of a cell range of the plurality of adjoining variable value cells. The plurality of cells also includes a spill area into which data can flow from a cell having an expression defined therein in response to the expression including a variable range defined by the plurality of values of the variable. The spill area is automatically sized to a plurality of expression solutions corresponding to the plurality of values of the variable.

According to yet another aspect of the present embodiments, a method for presentation of a dynamic website is provided. The method includes generating the presentation of the dynamic website in response to a single spreadsheet document, the single spreadsheet document including data and business logic and the presentation of the dynamic website method generated in response to the data and the business logic of the single spreadsheet document.

According to yet an additional aspect of the present embodiments, a spreadsheet is provided. The spreadsheet includes a plurality of cells arranged in a two-dimensional array. One or more of the plurality of cells include user-designated constraints designed to evaluate to non-error and non-false values.

According to yet a further aspect of the present embodiments, a method for spreadsheet programming is provided. The method includes user-designating one or more cells of the spreadsheet to include constraints designed to evaluate to non-error and non-false values. The method also includes performing an action on at least one of the one or more cells of the spreadsheet, rejecting the action in response to the action causing at least one of the constraints to fail, and restoring the spreadsheet to a state before the action was performed in response to the action causing the at least one of the constraints to fail.

According to a further aspect of the present embodiments, a method to accelerate searching for a value in arbitrary blocks of cells of a spreadsheet is provided. The method includes utilizing a spatial index and defining a total order of possible cell values.

According to a final aspect of the present embodiments, a spreadsheet is provided. The spreadsheet includes a plurality of cells arranged in a two-dimensional array defined by a plurality of rows and a plurality of columns. Each of the plurality of rows is identified by a bignum row number and each of the plurality of columns is identified by a bignum column number. Each bignum row number and each bignum column number comprise a number capable of arbitrarily high finite precision in its binary representation.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 is an illustration of an exemplary spreadsheet spill in accordance with present embodiments.

FIG. 2, comprising FIGS. 2A to 2D, depicts illustrations of spreadsheet oscillating spill areas in accordance with present embodiments, wherein FIG. 2A depicts a potential oscillating spill area, FIG. 2B depicts a first state of the oscillating spill area, FIG. 2C depicts a second state of the oscillating spill area, and FIG. 2D depicts a steady final state of the oscillating spill area.

FIG. 3, comprising FIGS. 3A, 3B and 3C, depicts reuse logic by substitution in accordance with the present embodiments, wherein FIG. 3A depicts an exemplary tax computation sheet, FIG. 3B depicts the exemplary tax computation sheet of FIG. 3A with substitutable cells defined, and FIG. 3C depicts an exemplary sheet tax after substitution of values in the exemplary tax computation sheet of FIG. 3B.

FIG. 4, comprising FIGS. 4A, 4B and 4C, depicts sheets exemplifying rules for simple substitutions and nested substitutions in accordance with the present embodiments, wherein FIG. 4A depicts a first sheet used in the examples of substitutions in FIGS. 4B and 4C, FIG. 4B is a simple substitution, and FIG. 4C is a nested substitution.

FIG. 5, comprising FIGS. 5A to 5D, depicts sheets exemplifying callback rules in accordance with the present embodiments, wherein FIG. 5A depicts a labelled sheet, FIG. 5B depicts a callback to the sheet of FIG. 5A, FIG. 5C depicts a labelled sheet, and FIG. 5D depicts a thunk callback to the sheet of FIG. 5C.

FIG. 6, comprising FIGS. 6A and 6B, depicts operation of a rule for spill barriers in accordance with the present embodiments, wherein FIG. 6A is a sheet with a spill barrier defined and FIG. 6B is a substituted sheet where the spill barrier automatically creates cells in an elastic row in order to accommodate additional values.

FIG. 7 depicts use of label position expressions in accordance with the present embodiments

FIG. 8, comprising FIGS. 8A, 8B and 8C, depicts operation of a rule for style regions in accordance with the present embodiments, wherein FIG. 8A depicts a style table, FIG. 8B depicts a sheet having a style region defined by the style table of FIG. 8A, and FIG. 8C depicts a table a style region programmed for a three row/two column portion of a spreadsheet.

FIG. 9, comprising FIGS. 9A and 9B, depicts operation of a rule for table-within-tables (TWITs) in accordance with the present embodiments, wherein FIG. 9A depicts a sheet with unpleasantly wide cells below a title cell and FIG. 9B depicts the contents of the sheet of FIG. 9A with a defined TWIT to provide a better visual appearance.

FIG. 10, comprising FIGS. 10A and 10B, depicts operation of classes as directories in accordance with the present embodiments, wherein FIG. 10A depicts creation of a table of the rectangle class and FIG. 10B depicts computation of an area of a rectangle.

FIG. 11 depicts a spreadsheet importing the document described by FIGS. 10A and 10B at a certain node in accordance with the present embodiments.

FIG. 12, comprising FIGS. 12A and 12B, depicts a diagram of a spreadsheet defining a dynamic survey website in accordance with the present embodiments, wherein FIG. 12A depicts the spreadsheet before entry of survey answers and FIG. 12B depicts the spreadsheet after entry of one survey answer.

FIG. 13, comprising FIGS. 13A and 13B, depicts a rendered spreadsheet after execution of the “index” macro at the entry point to the user interface layer in accordance with the present embodiments, wherein FIG. 13A depicts the rendered spreadsheet when the rectangular region indicated by the expression “joe_id -| (answer:last_answer):” contains no blanks and FIG. 13B depicts the rendered spreadsheet when the rectangular region indicated by the expression “joe_id -| (answer:last_answer):” contains blanks.

FIG. 14 depicts a spreadsheet including purchasing data, the queries on which can be accelerated by the use of spatial indices in accordance with the present embodiments.

And FIG. 15, comprising FIGS. 15A, 15B and 15C, depicts spreadsheets with table-within-tables (TWITs) in accordance with the present embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of present embodiments to present a user-facing spreadsheet-based programming language that allows a user to build, test, and reuse logic blocks, to build dynamic web sites, and to build large-scale shared spreadsheets, all while staying completely within the constraints of a two-dimensional (2D) spreadsheet. The intent is further to put 2D spreadsheets on an equal footing with today's general-purpose programming languages.

Many visual languages were invented in pursuit of bringing general-purpose programming to the masses, but dragging little shapes across screens proved to be too cumbersome with very limited expressiveness. Some visual languages survive in niches that map well to a graphical representation, such as MATLAB Simulink for signal processing and Unreal game engine's Blueprints for scripting gameplay elements, but none is considered viable as a general-purpose programming environment.

Referring back to the visual environment of 2D spreadsheets having a two-dimensional array of cells, in today's conventional spreadsheets defining an expression for a single cell is fairly straightforward. Cells can be referenced either by their coordinates, like A1, or by assigning labels. In accordance with the present embodiments, the method of assigning labels is exclusively utilized for referencing cells.

In conventional spreadsheets, filling an area relies essentially on copying and pasting expressions. How the cells should behave when a row is inserted in the middle or when one of the expressions is changed by the user is difficult to determine. Should the new row automatically be filled with the current pattern? Should the same expression change apply to cells that were pasted from it? The ambiguity is dangerous by itself, but more importantly, the ambiguity thwarts the effort to reuse the spreadsheet's logic with any certainty.

Some current spreadsheet systems have array expressions to mitigate the problem. However, the user must explicitly specify a range of cells for application of the expression and what happens when the input range changes size is still not clear. In recognition of this fragility of copied logic and other conventional spreadsheet issues, a plurality of spreadsheet programming rules in accordance with the present embodiments are defined to overcome the drawbacks of current conventional spreadsheet programs.

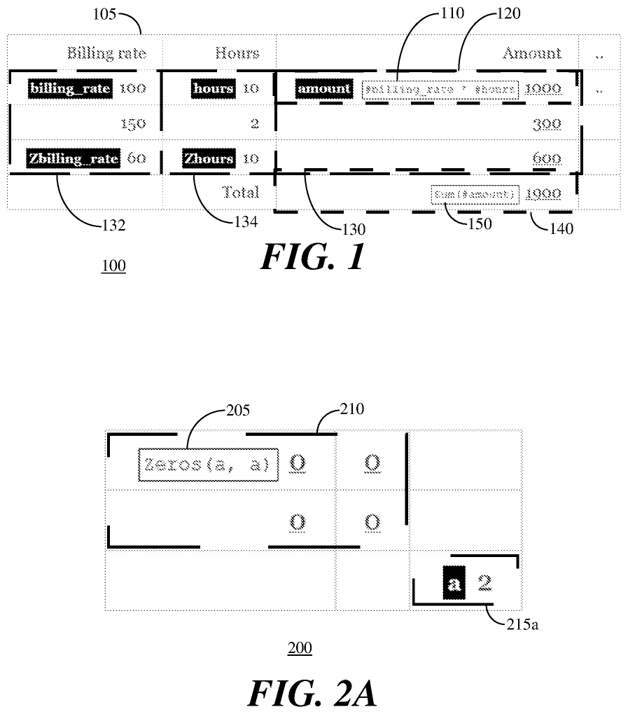

In accordance with a first aspect of the present embodiments, cell spill areas are defined for robust and advantageous auto-filling of a range of cells in a spreadsheet. Referring to FIG. 1, an illustration 100 depicts a spreadsheet spill in an exemplary spreadsheet 105 in accordance with the present embodiments. The user only defines a single expression 110 in the top-left cell 120, of an area 130, without having to specify a size. The head 120 evaluates the expression 110 not necessarily to a single value, but in accordance with the present embodiments can evaluate the expression 110 to a rectangular table of values. The values then spill to cells on the right and to the bottom of the cell with the expression as necessary. If any cell in the spill area already has a value set, or is also spilled into from another cell, then a spill conflict is reported as discussed hereinbelow.

In the expression 110, #billing_rate is a shorthand variable for billing_rate:Zbilling_rate, which is a user defined pair of labels which denotes a rectangular area of adjoining variable value cells from the cell with label billing_rate to the cell with label Zbilling_rate, both inclusive, which contain data 100 \\ 150 \\ 60 corresponding to a plurality of values of the variable #billing_rate. Similarly, #hours denotes the rectangular area of adjoining variable value cells from hours to Zhours. In the exemplary spreadsheet 105, cell 120's expression 110 #billing_rate*#hours multiplies the two tables 100 \\ 150 \\ 60 for areas 132 and 10 \\ 2 \\ 10 for area 134 together to produce a table of 3 rows and 1 column 1000 \\ 300 \\ 600. Since this table cannot be contained in cell 120 itself, it spills into the two cells below, making cell 120's spill area 130. Subsequently, in expression 150, without an explicit label Zamount defined in sheet 105, #amount denotes this spill area 130 of cell 120 amount, including the cell amount itself. The entire expression Sum(#amount) 150 in the cell 140 thus computes the sum of the spill area 130 of cell 120 amount, 1000+300+600=1900.

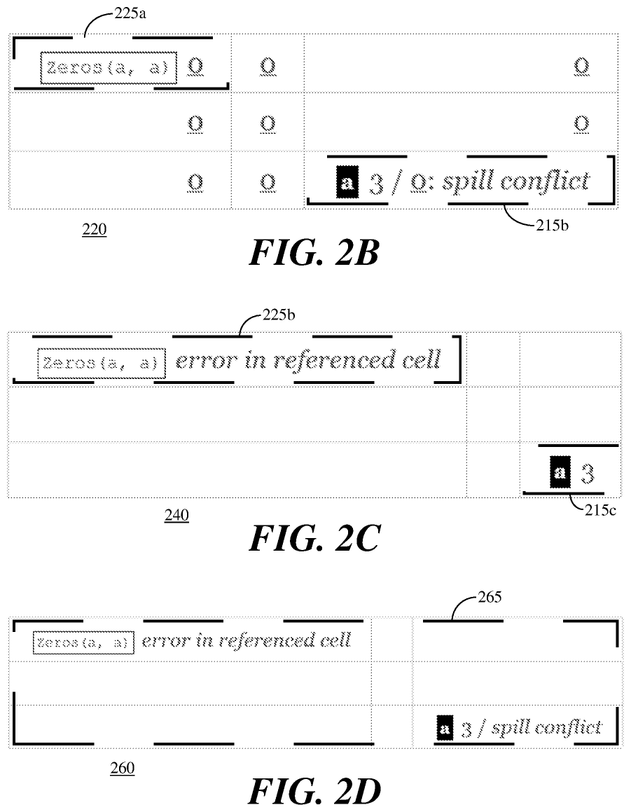

Of particular note is the problem of oscillating spill areas. Referring next to FIGS. 2A, 2B, 2C and 2D, illustrations 200, 220, 240, 260 depict spreadsheets exemplifying the problem in accordance with the present embodiments. In the illustration 200, a function Zeros(a, a) 205 generates a table 210 of size a by a filled with zeros in response to a in cell 215a set equal to “2”.

If the user were to change the value a to “3” as shown in the cell 215b of the spreadsheet 220, the spreadsheet will then oscillate between two states: State One shown in the illustration 220 (FIG. 2B) where we have enlarged the spill area of the top left cell 225a to 3×3, causing the cell 215b to report a spill conflict, thereby causing a pending re-evaluation of the cell 225a; and State Two shown in the illustration 240 (FIG. 2C) where the top left cell 225b has an error value and therefore no spill area beyond itself, and the cell 215c has the value of “3” with no spill conflict.

In order to address the issue of oscillating spill areas and in accordance with an aspect of the present embodiments, a spill area rule is defined that spill areas are non-shrinking, that is, they can only enlarge before subsequent user inputs. Following this spill area rule, the spill area of the top-left cell remains a 3 by 3 spill area 265 even in State Two, resulting in the steady final state shown in the illustration 260 (FIG. 2D).

In accordance with the present embodiments, this spill area rule will advantageously always result in a steady final state in the absence of new user input. Intuitively, the number of pairs of spill areas conflicting each other is capped by the pairs of expressions defined. If spill areas cannot shrink, then the number of such relationships must converge to a steady value. Once the spill area conflict relationships have stabilized, a cell value can either be computed unambiguously; otherwise it's part of a dependency loop that can easily be detected and reported as such.

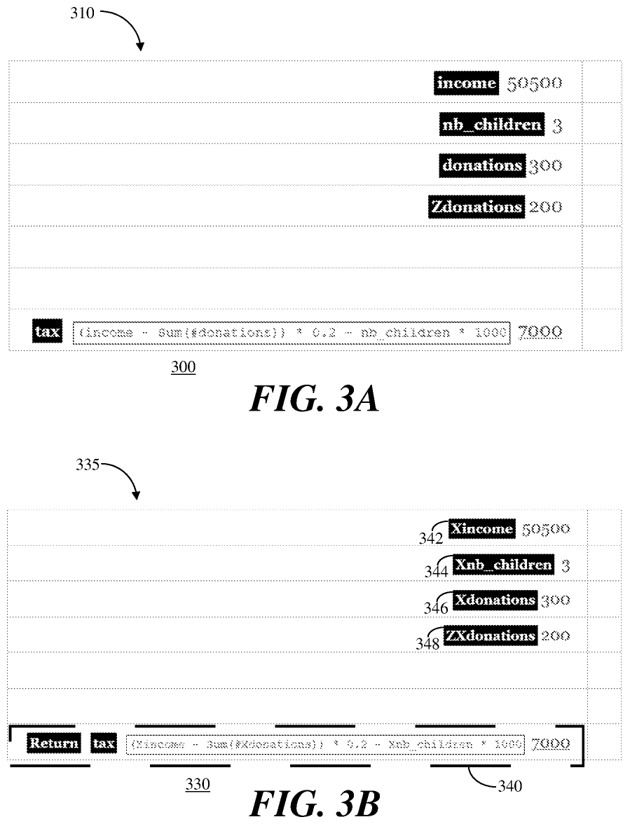

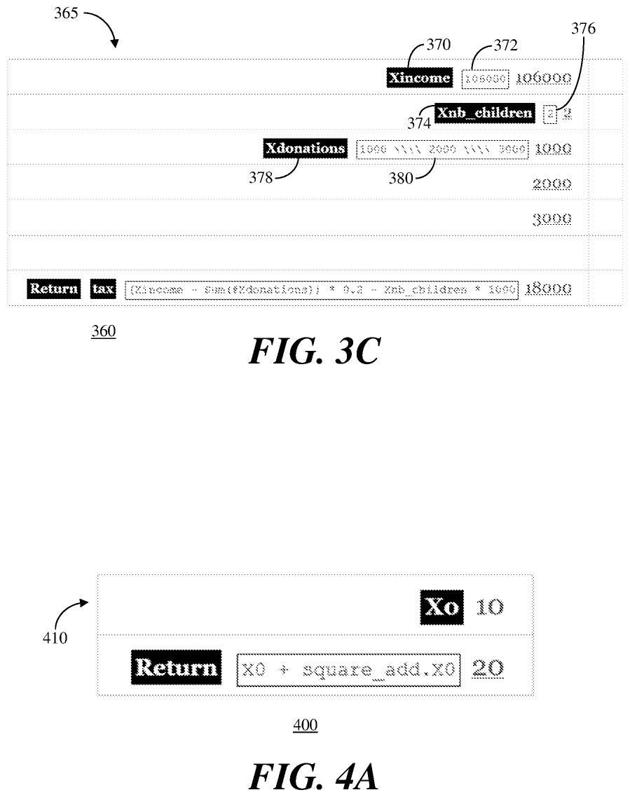

Another issue with conventional spreadsheets is that it is challenging to reuse logic defined in another spreadsheet. Referring to FIG. 3A, an illustration 300 depicts a sheet 310 which is defined to compute the hypothetical tax due for an individual. Even though the logic is clearly written out, conventional spreadsheets do not provide an adequate way to apply the logic defined in the sheet 310 to another individual's taxes. Either the input values of the income, the number of children (i.e., nb_children), etc are redefined, therefore destroying the currently computed values, or the logic must be duplicated into another sheet and modified in place there, even though duplicating code is usually strongly discouraged in programming.

In order to overcome this deficiency in conventional spreadsheets, a substitution rule is defined in accordance with the present embodiments to support logic reuse by substitutions. Referring to FIG. 3B, an illustration 330 depicts a sheet 335 with substitutable cells 342, 344, 346, 348 (those labels that start with X) defined. With sheet 335, cell 340 can be defined to be the Return value of tax, the logic to compute the tax. For example, the code can be written tax(income=106000, nb_children=2, donations=1000 \\ 2000 \\ 3000) to compute the tax for another hypothetical person. This code represents a substituted sheet of tax with a few amendments as depicted in FIG. 3C, and takes the value of #Return in the substituted sheet as its value. Positional inputs in the sheet 335 are supported if labels such as X0, X1 are defined.

Referring to FIG. 3C, an illustration 360 depicts a sheet 365 represented by the code tax(income=106000, nb_children=2, donations=1000\\2000\\ 3000). The sheet 365 is copied from the sheet 335 tax, with the cell Xincome 370 replaced with the code 106000 372, the cell Xnb_children 374 is replaced with the code 2 376, and the cell Xdonations 378 is replaced with the code 1000 \\ 20000 \\ 3000 380. The code set for other cells in the range Xdonations: ZXdonations are also removed, that is ZXdonations=200 in sheet 335 is removed. By removing the label ZXdonations, the value of Xdonations 378 defined by the code 1000 \\ 20000 \\ 3000 380 is advantageously allowed to successfully spill into the cells below it, while the meaning of #Xdonations remains well defined and conforms to a user's expectations.

Positional inputs are supported using labels of the pattern X0, X1. For example, a code tax(106000, 2, donations=1000\\2000) would constitute substitutions of X0 with code 106000, X1 with code 2, and named input Xdonations substituted as described previously.

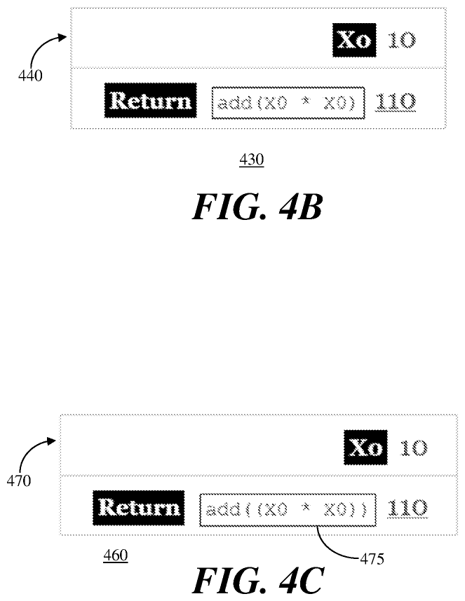

An issue with substitutions as defined above is nested substitutions. Referring to FIGS. 4A and 4B, illustrations 400, 430 depict sheets 410 add, and 440 square_add. An ambiguity arises when we wish to evaluate square_add(20). It is unambiguous that square_add.X0 should be substituted with 20, which in turns causes square_add.Return to request add(400). Further, in the sheet 410 add, it is unambiguous that X0 should be substituted with 400, but in add.Return, it's not clear what square_add.X0 should be. There are two possible interpretations. The first interpretation is that square_add.X0 should be 10 because in the substitution add(400), square_add.X0 is not substituted. This first interpretation is termed a simple substitution and is more performant because there are fewer substitutions, but it could be somewhat surprising. The second interpretation is that square_add.X0 should be 20, because add(400) is nested in the substitution square_add(20) where square_add.X0 is substituted as 20. This second interpretation is termed a nested substitution and is more costly to compute.

As both interpretations have their uses, the second interpretation is denoted using double parentheses to distinguishably designate it differently from the first interpretation. So, referring to a sheet 470 in an illustration 460 of FIG. 4C, if the second interpretation is desired, the Return cell 475 of sheet square_add is written with double parentheses.

Another issue with substitutions as defined above is that usually many cells are not meant to be substituted with a table. For example, the tax sheet is not designed with the substitution nb_children=1\\3 in mind and should preferably generate an error. Thus, in accordance with the present embodiments, the shape of the substitution values must agree with the original shape. That is, since #Xnb_children in the original tax sheet is a single cell, its substituted value must also be a single cell. Similarly, since #Xdonations is originally a column, its substitution must also be a column. A single cell is considered a special case of a column, therefore it is also an acceptable substitution here. Four shapes are differentiated: a single cell, a row (also allows a single cell), a column (also allows a single cell), and a full table (allows all three preceding shapes). With this feature, tax(nb_children=1\\3) generates a “shape mismatch” error.

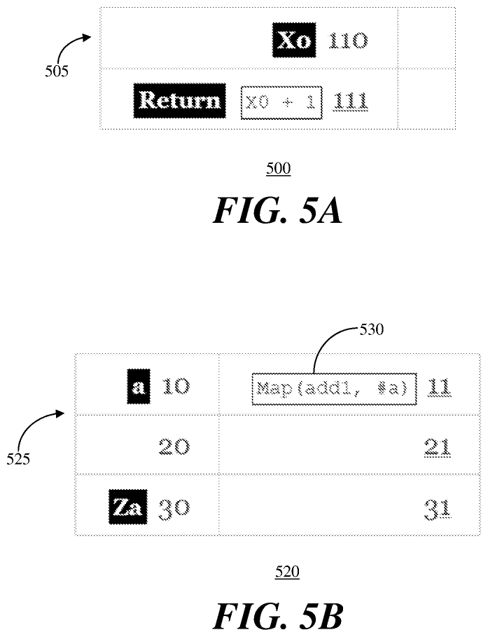

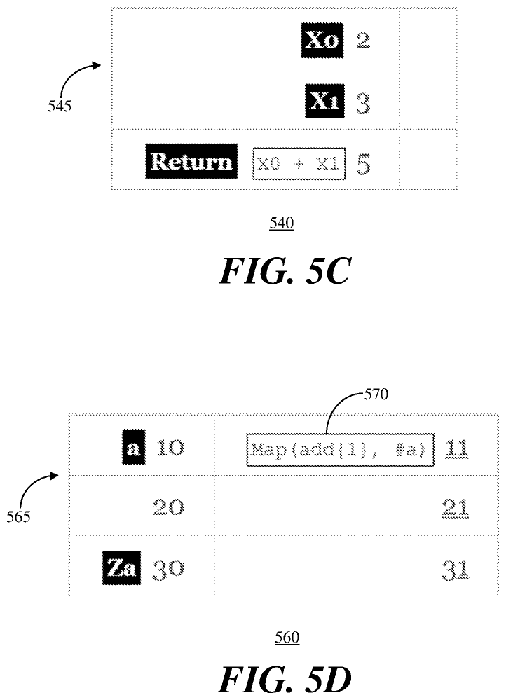

It has now been shown how a spreadsheet in accordance with the present embodiments can act analogously to functions in conventional programming languages. Similarly, spreadsheets can be partially bounded with parameters, like conventional functions. A sheet name, together with a possibly empty set of substitutions of labels to values, is called a thunk in accordance with the present embodiments. A cell can be assigned a thunk as its value. In accordance with a further aspect of the present embodiments, thunks can be passed in as function arguments, enabling the use of callbacks and/or higher-order functions. Referring to FIGS. 5A and 5B, illustrations 500, 520 depict a sheet 505 named add1, and a sheet 525 exemplifying a rule for callbacks in accordance with the present embodiments. The sheet 525 passes the callback add1 to the call to Map, a built-in function.

Further to the example above, we note that it's impractical to have to define an addN for every N. Referring to FIGS. 5C and 5D, illustrations 540, 560 depict sheets 545, 565 exemplifying a rule for partially bound thunk callbacks in accordance with the present embodiments. Where the sheet 545 is named add, an expression add{1} 570 represents a partial binding of the sheet 545 add, producing a thunk that's functionally equivalent to add1 505. A thunk can also take more substitutions, creating further thunks. As an example, the following are all equivalent: (a) add(1,2), (b) #add{1,2}.Return, (c) add{1,2}( ), (d) add{1}(2), and (e) add{1}{2}( ).

Similar to the distinction of simple substitution versus nested substitution ( ) and (( )), discussed hereinabove, thunk substitutions can be either simple or nested as denoted by { } and {{ } } respectively.

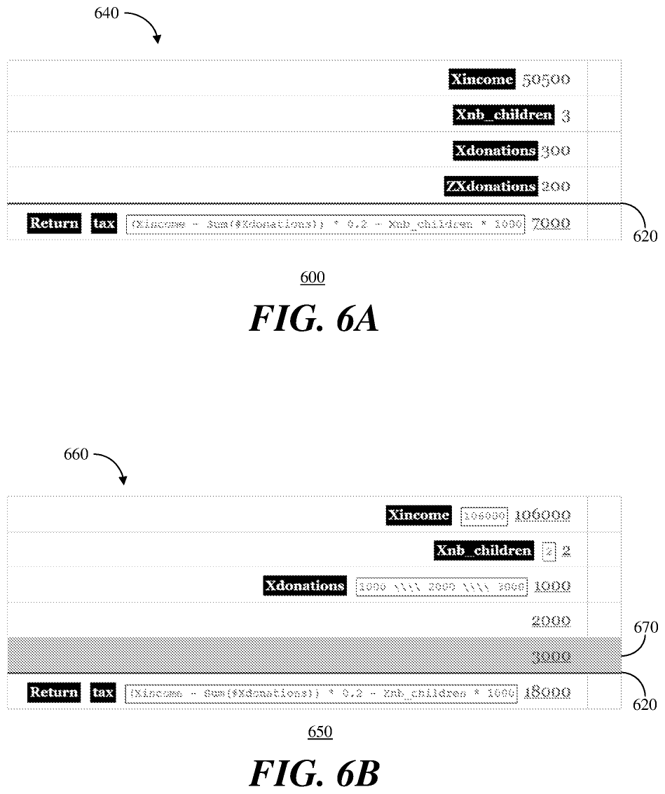

Since range substitutions are allowed, no matter how far blocks of cells are placed apart, all possible spill conflicts cannot be avoided. Referring to the spreadsheet 360 (FIG. 3C), if someone made more than four donations, the Return cell would get a spill conflict. Thus, a rule for spill barriers is defined in accordance with the present embodiments. Referring to FIGS. 6A and 6B, illustrations 600, 650 depict operation of the spill barrier rule in accordance with the present embodiments. The illustration 600 depicts the tax sheet 640 with a spill barrier 620 defined to establish an elastic limit to a spill area in accordance with the present embodiments. Spills cannot cross barriers; instead, the barrier creates elastic spill areas as needed to contain the spill values. Cells in an elastic spill area cannot have user defined labels or expressions. In a substituted tax sheet 660 in the illustration 650, the spill barrier 620 enables automatic creation of cells in a row 670 in an elastic spill area in order to accommodate an additional donation value that would otherwise cause a spill conflict.

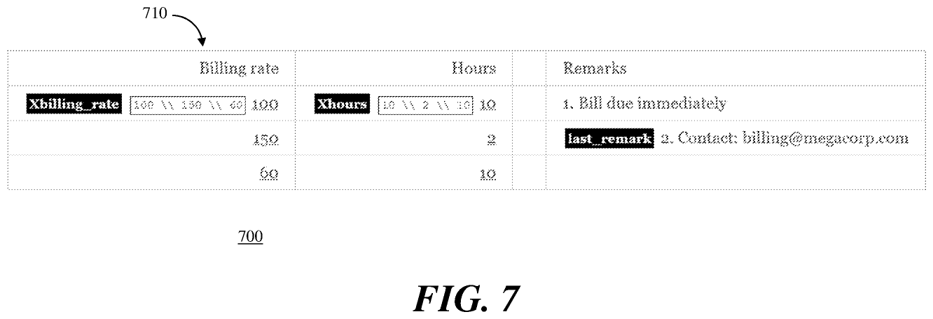

Referring to FIG. 7, an illustration 700 depicts a spreadsheet 710. Suppose a user wishes to express a range denoting all the content of the sheet. Noting that Xbilling_rate and Xhours are both substitutable and hence can have any height, the user can use label position expressions to precisely describe the logic required. Label position expressions are expressions that operate on the coordinates of labels, instead of a value referred to by the labels. Examples are: (a) Xbilling_rate \hat{ }\hat{ } 1 refers to the coordinate of the cell one row above the label Xbilling_rate; (b) Z(Xbilling_rate) refers to the bottom-right corner of the spill area of the cell Xbilling_rate, i.e. the cell with value 60; and (c) BottomRight(Z(Xbilling_rate), last_remark) refers to the top-left-most cell that's to the bottom, or to the right, or to the bottom-right of both Z(Xbilling_rate) and last_remark, i.e. the empty cell below last_remark. With these definitions, the user can elegantly express the concept “all the content on the sheet” with the expression Xbilling_rate\hat{ }\hat{ }1: BottomRight(Z(Xbilling_rate), last_remark), regardless of what values Xbilling_rate and Xhours are substituted with.

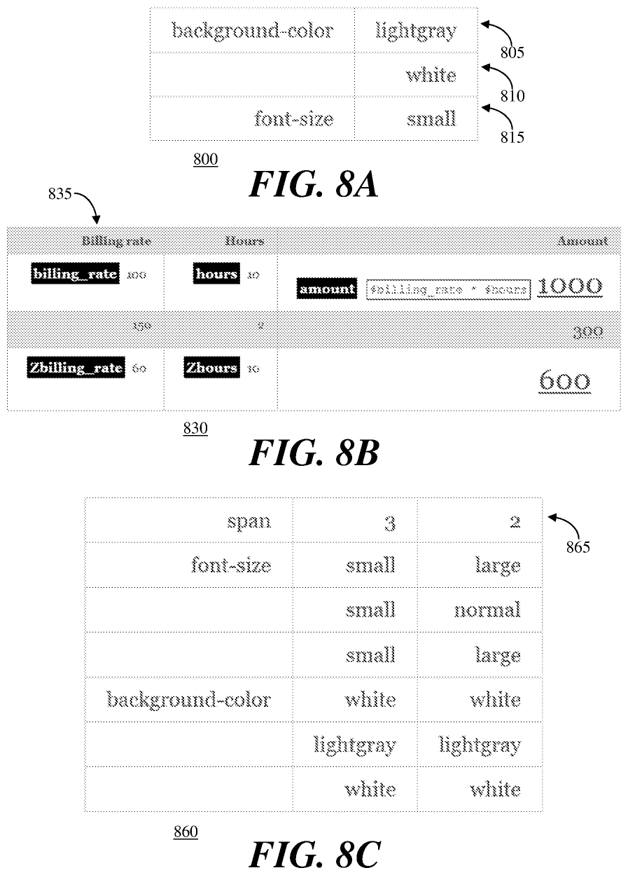

The usual way to style a spreadsheet is to manually select an area, then select a style to apply. This breaks down in the face of spills and substitutions. Thus, in accordance with the present embodiments a user can define multiple style regions for each sheet, ranked in priority. Unlike spill areas, style regions can overlap. Cells in overlapping regions accumulate the style specifiers from all covering regions. If the styles specified are conflicting, then that with a higher priority is effective. Each style specifier is itself a normal expression that evaluates to a 2D table, and is tiled to fill the whole region. For example, we specify for sheet 835 in FIG. 8B the following style regions, ranked from high priority to low: (a) from billing_rate \hat{ }\hat{ } 1 to amount \hat{ }\hat{ } 1, style “font-weight” & “bold”, (b) from amount to Z(amount), style “font-size” & Where(#amount >500, “large”, “normal”), and (c) from billing_rate \hat{ }\hat{ } 1 to Z(amount), style “background-color” & (“lightgray”\\ “white”) \\ “font-size” & “small”. The style definition evaluates to a table 800 in FIG. 8A, where a first row 805 and a second row 810 define background-color to alternate between lightgray and white, and a third row 815 defines font size as small.

Referring to FIG. 8B, an illustration 830 depicts a sheet 835 incorporating the style definitions (a) to (c) as defined previously. Note that the font-size specifier of the second rule (b) overrides the font color specifier of the third row 815 of the table 800.

Alternatively, the user can also leave the to label empty, and specify “span” & 3 & 2 in the style to apply the style to a region of three rows and two columns starting from the from label. Once defined, the style of a region is accessible programmatically. For example, Style(a, b) retrieves the styles of the range from cells a to b. Referring to FIG. 8C, a table 860 depicts how Style(hours, Z(amount)) would evaluate for the sheet 835. Note that in the table 860, the Style( ) call automatically generates the row 865 “span” & 3 & 2. This allows one to easily copy one region's styles to another region by assigning Style(#source) to the destination cell.

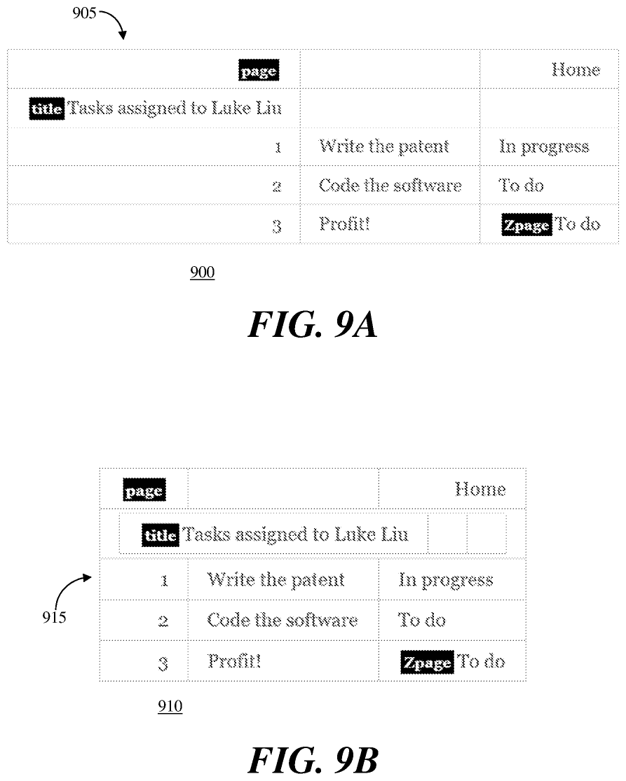

When a cell becomes very wide, it forces semantically unrelated cells below to be unpleasantly wide. Referring to FIG. 9A, an illustration 900 depicts a table 905 having unpleasantly wide cells below a title cell. Conventional spreadsheets allow cells to be merged to alleviate this problem. However, cell merges violate the strict 2D grid and is difficult to reconcile with other features, such as spills and style regions. Accordingly, a rule for table-within-tables (TWITs) is defined in accordance with the present embodiments to isolate wide rows and tall columns.

A user can specify a TWIT, where a region is rendered as a mini-table inside a larger table, usually that of a whole sheet. The number of rows, the number of columns, and the total area occupied are preserved, but the individual row heights and column widths can otherwise be freely adapted to the content of the cells. In accordance with the present embodiment, a TWIT from title to title >>2 can be defined in the sheet 905. An illustration 910 of FIG. 9B depicts a sheet 915 incorporating the above defined TWIT, thereby advantageously providing a better visual appearance.

TWITs can nest but not intersect. That is, two TWITs are either completely disjoint, or one is contained completely in the other, but their borders cannot intersect. Intersection TWITs, defined as TWITs with intersecting borders, are ignored.

A row of sheets is hard to organize: conventional spreadsheets have no hierarchy as all sheets are arranged in a row. In order to overcome this deficiency in conventional spreadsheet programs, spreadsheets are made hierarchical in accordance with another aspect of the present embodiments. Each sheet can have child sheets, much like a folder can contain files and also more folders, except that the sheet acts as both a folder and a file. There are several benefits to making sheets hierarchical in accordance with the present embodiments other than a hierarchy being more logical. For example, the hierarchy maps easily to URLs when exporting the spreadsheet document as a website. In addition, it is easier to assign meta-data, such as read/write permissions, to a group of sheets rather than assigning meta-data individually to sheets one by one. Also, the hierarchy forms the basis of defining classes, as discussed hereinbelow.

Most conventional mainstream programming languages support classes in some form, which to a first approximation are a bundle of data and associated functions. For example, the call a.area( ) executes different code depending on what class the value a belongs to. In accordance with a further aspect of the present embodiments, a dynamically specified spreadsheet reference can be substituted into the spreadsheet in response to cell values of a cell in the spreadsheet, where the dynamically specified spreadsheet reference includes a dynamically specified directory reference and a spreadsheet name of another spreadsheet. Thus, the behavior of classes is emulated by dynamic directory references that is understandable in the context of a spreadsheet.

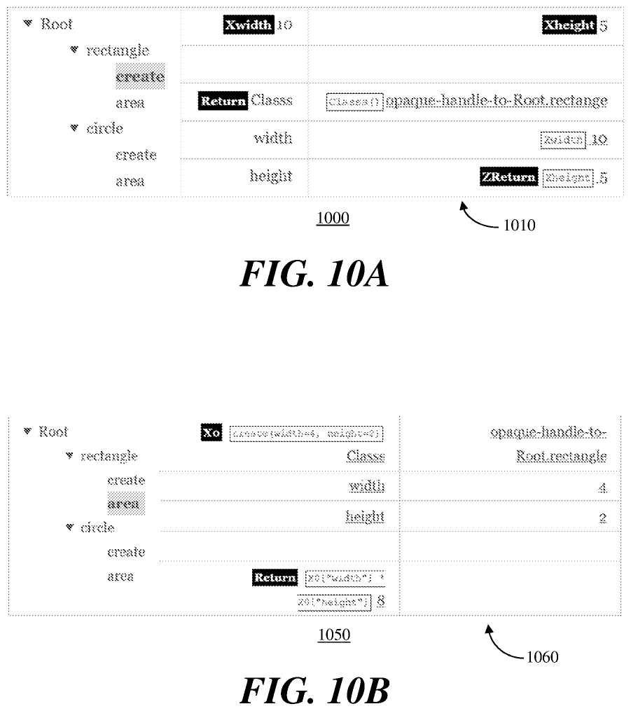

If the first row of a table is “Classs” & “reference-to-directory”, then the table is considered to be of the class of the said directory. The keyword Classs is intentionally misspelled to minimize the chance of a random table having the correct keyword, although the choice of the actual keyword is not essential in the context of this invention. The special syntax a->area( ) is then translated to the call directory.area(a). The expression directory.area is a dynamic sheet reference, comprising of a dynamic directory reference and a sheet name. As an example, FIGS. 10A and 10B depict illustrations 1000, 1050 of how the rectangle class works. A create sheet 1010 in the illustration 1000 acts as a function that creates a new table of the rectangle class given the width and height, while an area sheet 1060 in the illustration 1050 computes the area of a rectangle. These definitions allow code such as the following to be well defined: rectangle.create(width=3, height=3)->area( ). Note how circle.create(radius=3)->area( ) would call the sheet circle.area instead. The syntax #X0[“width”] means to search for the string “width” in the first column of the given table #X0, and to take the value to right of it as the value of the expression.

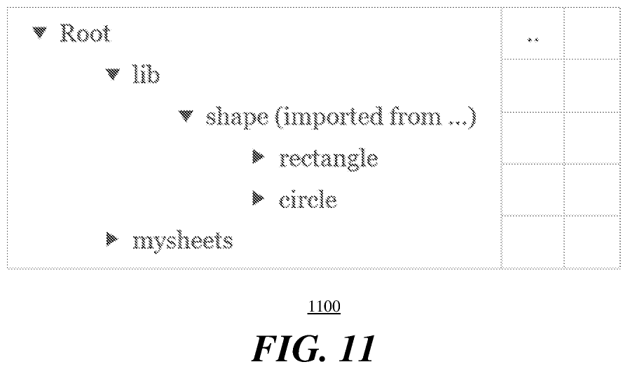

Importing third-party spreadsheets would allow one to share functions and classes with other users. Therefore, our invention allows a spreadsheet document to be imported as a node in a sheet tree. Referring to FIG. 11, an illustration 1100 depicts a spreadsheet importing the document described by the sheets 1010, 1060 at a certain node. The directory structure of the imported document is preserved.

As described above, the complete source code of the third-party spreadsheet document is imported and is then executed on the same computer as the rest of the document. Sometimes it is instead desired that the imported spreadsheet remains on the third-party computer and execute on that computer and the user is only be informed of the results. There could be a few reasons for this. For example, the third-party sheet is proprietary and the author does not wish to distribute the source code. Or, the execution is resource intensive or requires specialized hardware and is best executed by the third party.

In accordance with the present embodiment, we allow multiple sheets residing on different computers to form one logical distributed document. The major challenge in this type of system is cycle detection, where some cell a residing on computer A depends on some cell b residing on computer B, which depends on some cell c residing on computer C, which in turn depends on cell a. In a fully general system where any cell can reference any possibly remote cell like in the present example, dependency detection is a hard problem. The present invention therefore proposes a limited star-shaped form that is easier to work with while remaining useful.

Only one computer is considered the hub for the document, and can reference any remote sheets as it wishes. Other computers, called libraries, cannot reference back to the hub or any other computers, except via remote thunks passed in by the hub as parameters. For example, someone develops a ticket management system as a collection of sheets that they don't want to release the source code for, and hence the ticket management system runs on the developers' computer as a library. A user can then incorporate this library as remote sheet. However, the library does not know by itself which users can log in or can have access to which tickets, this is essentially a policy that the user has to set. So, as configurations the user passes an authenticated thunk and an authorized thunk, to define rules for password validation and access control, respectively. These thunks stay on the user's computer and only the thunk IDs are passed to the computer running the library. When the library needs to execute the thunk and realizes that the thunk ID is not available locally, the third-party system will send a subscribe request back to a user's computer a.k.a. the hub.

Dependency loop detection in accordance with the present embodiments is made simpler by the fact that a star-shaped dependency is maintained. Two libraries referenced by the hub cannot talk to each other directly; they can only talk to the hub of the document. When libraries publish cell value updates to the hub, they also list all the values on the hub used to compute this value. This way, whenever there's a dependency loop, the hub can easily detect it and set the relevant cells to have a dependency loop error. Note that a library is free to act as the hub of further libraries, as long as those further libraries are invisible to its hub. So, the ticket management library can itself import other libraries, but it'll still appear as a single monolith to the user. The loop detection algorithm in accordance with the present embodiments is agnostic to the internal implementation of the ticket management library.

In accordance with the present embodiments, collaborative sheets are provided. In the simplest case, collaborative sheets are merely multiple UIs connected to the same backend, each sending commands like set a cell's code and set a horizontal barrier, and receiving cell updates from the backend.

Things get more interesting when access control is enabled. Conventional collaborative spreadsheet systems have very coarse access control. For example, Google sheets have several permission bits per user for the whole document, such as whether the user can edit the document, whether the user can read the document, or whether the user can comment on the document. Such a simplistic model, however, is often not adequate.

For example, a company may wish to put all its administrative and operational data into one huge document. The HR data live in one subtree, including sensitive information such as everyone's salary, which must be visible only to HR staff. Customer support data live in another subtree. In this subtree, the customer support team plans to build a ticket management system. They wish to use HR's record of who's in which department, which is not sensitive information, to assign roles in their ticket management system. As they should not have direct access to the HR data, someone in HR needs to extract the departmental information and specifically grant permission so that the customer support team can read that data.

Clearly the coarse access controls in conventional systems are inadequate in such a scenario. However, a naive approach that simply defines who can read and write to each sheet is easily circumvented. For example, suppose sheet secret is only accessible to the HR, and sheet public is readable and writable by everyone. Any user can easily set a cell X in sheet public to have code secret.everyones_salary and read the cell X in sheet public.

Operation in accordance with the present embodiments defines per-sheet owner and readers. Per-sheet owners and readers include concrete users which are actual users and abstract users which are common denominators of some set of users. Together concrete users and abstract users are the users. Each user can act-as some set of other users. For example, a hypothetical company has the following users: (a) anyone: any user in the system (this is always present and anyone can act-as anyone), (b) hr-person (e.g., someone who works in HR and can act-as anyone), (c) customer-support-person (e.g., someone who works in customer support), (d) manager (e.g., any manager), (e) hr-manager (e.g., can act-as hr-person and manager), (f) chess-club-person, (g) Tyrion (e.g. can act-as hr-manager and chess-club-person), and (h) Samwell (can act-as customer-support-person and chess-club-person).

Act-as relationships are transitive, so, for example, Tyrion can act-as a hr-person, too.

In accordance with the present embodiments, every sheet has one user as its owner, which must be assigned statically, i.e. not computed. All expressions in the sheet are always executed with the permission of the owner, regardless of who is looking at the sheet. This way, everyone gets the same value, including permission denied errors.

In accordance with the present embodiments, every sheet can have zero or more users as its readers. This list can be computed, and can be dependent on substitutable cell values so that, for example, a sheet showing personal information has a reader list that depends on whose information is being shown. This is useful for letting people read their own information, but not other people's information. A sheet can be read by a user if (s)he can act-as the owner, or at least one of the readers.

In accordance with the present embodiments, a user can edit the sheet, including the list of readers, if (s)he can act-as the owner. To change the owner of a sheet, the logged in user must be able to act-as both the old owner and the new owner. Since one can only edit a sheet if (s)he can act-as the owner and the sheet is evaluated with the permission of the owner, one cannot gain privilege escalation by writing an expression in a cell.

If fine-grained permission is not required, every sheet's owner is set to anyone. This is also the default.

Multiple owners could be allowed for each sheet in accordance with the present embodiments. The contents in the sheet are then executed with the common denominator of all the owners. That is, in order to be able to read a cell from another sheet, all owners must be able to. Subsequently, a user can edit the sheet, including adding new owners, if they can act-as any of the owners. Essentially there is an unnamed single owner which is the common denominator of all the owners.

While the notion of spreadsheets has long proven to be the only programming environment accessible to the average computer user, the building of multiple layers of even simple dynamic websites around the notion of spreadsheets has not been realized. In accordance with the present embodiments, a single, coherent spreadsheet document is able to serve an entire CRUD website. In even a simple CRUD (Create/Retrieve/Update/Delete) web application, the developer needs distinct technologies at several layers. For example, front-end technologies such as HTML, Javascript or Cascading Style Sheets (CSS) are used to present a user interface to the end user, a business logic layer programming language such as PHP (Hypertext Preprocessor which is an open source general purpose scripting language), Java, or any of many other choices, are used to translate end user queries and actions into database queries and actions (typically translated into Structured Query Language (SQL)), and a database query language, typically also in SQL, is used to control a database that actually hosts the data.

Given the many choices of programming languages, frameworks, paradigms, and products available at each layer, practitioners often refer to the technologies selected to build a functioning product as a ‘technology stack’. For example, a MEAN technology stack uses MongoDB in the database layer, Express.js (built on top of Node.js in Javascript) in the business logic layer, and AngularJS javascript framework in the user interface layer, hence the acronym MEAN.

A technology stack presents a high barrier of entry (i.e., a steep learning curve) as learning even the basics of a simple technology stack may require months of intense effort for people with no prior programming experience, or even programmers not well versed in the relevant technologies. To professional web developers, switching to a different technology stack is still a daunting task.

This basic structure, and the associated barrier of entry, is present regardless of whether one is building the next Facebook or a simple web survey. Whereas the complexity is justified in the former case, it is overly complicated in the latter case, making a seemingly simple thing completely impossible to anyone but professionals.

One can presently save a spreadsheet as HTML pages to be displayed as a static website. But the same cannot be said of dynamic websites whose contents are generated on the fly by querying data sources and doing computation, even though the logic and layout have been defined in the spreadsheet. Currently such a website must be reimplemented again from scratch, with the spreadsheet as a reference, but no actual code reuse is possible.

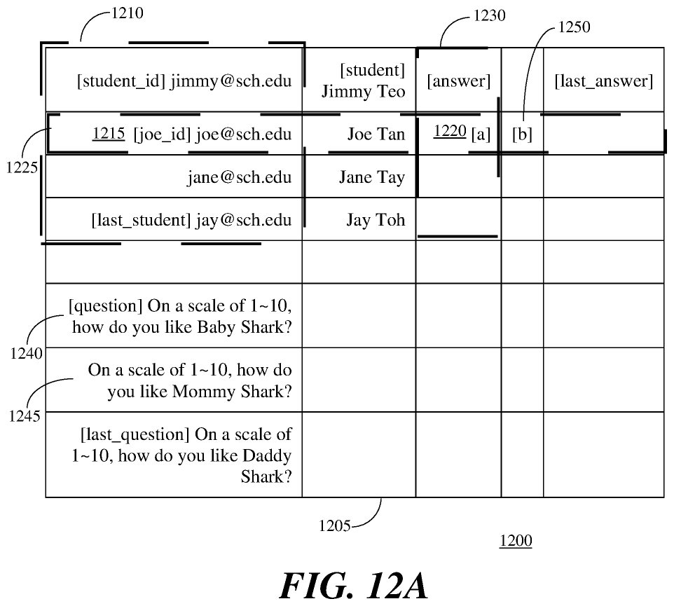

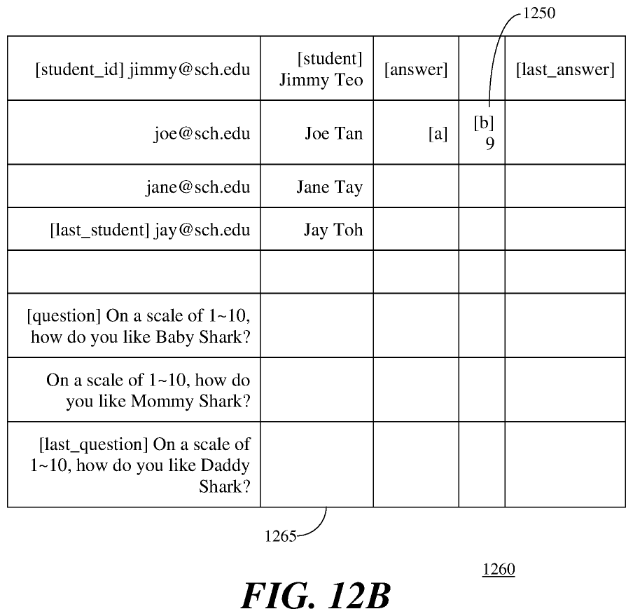

Referring to FIG. 12A, a diagram 1200 depicts a sheet 1205 of a document survey which serves to define a dynamic website, where, in accordance with the present embodiments, the document contains all the data, business logic, and presentation coding. The example represented by the diagram 1200 depicts a survey website where a teacher wishes to collect answers to three feedback questions from four students in a class. Instead of having to create and administer a database, the teacher creates a sheet data 1205 in the spreadsheet document survey to hold the relevant data. This is analogous to the database layer described previously. The text in square brackets denotes labels assigned to cells.

Next, the teacher builds the business logic of recording the survey result when a submission is received. Specifically, the teacher makes a macro named on_student_submit, consisting of the following content:

PasteCell! (Locate(Xstudent, student_id:last_student) -| answer)>>Xqid, Xanswer; index!; (1)

A macro simulates a user action, like in conventional spreadsheets. Suppose the submission is:

student=joe@sch.edu

qid=1

answer=9 (2)

where Xstudent refers to the student field in the submission, i.e. joe@sch.edu to be looked up in a region 1210.

In the macro (2), “Locate(Xstudent, student_id:last_student)” locates the cell 1215 with the content joe@sch.edu, in the range of cells in the region 1210 from student_id to last_student. In this example, that would be the cell 1215 having the label joe_id.

In the macro (2), “Locate(Xstudent, student_id:last_student) -| answers” refers to a cell 1220 at the intersection of row “Locate(Xstudent, student_id:last_student)” (i.e., the row 1225 including the cell 1215) and the column “answers” (i.e., the column 1230) which would be the cell 1220 including the label [a] in the diagram 1200.

In the macro (2), “>>Xqid” means moving to the right by Xqid cells. Note that the question IDs are 0-based, where question ID 0 refers to the question “how do you like Baby Shark” 1240 and question ID 1 refers to the question “how do you like Mommy Shark” 1245. The entire expression “(Locate(Xstudent, student_id:last_student) -| answer)>>>Xqid” refers to the cell 1250 including the label [b].

“PasteCell! b, Xanswer;” pastes the content of the answer field of the submission to the cell 1250 including the label [b] as if the user had pasted such content into cell 1250. And “index!;” invokes the macro named ‘index’ as explained hereinbelow.

Thus, referring to FIG. 12B, after the macro execution, the sheet data 1205 from the diagram 1200 looks like the sheet data 1265 in the diagram 1260, which has the new answer “9” recorded in the cell 1250. Then the macro ‘index’ is invoked.

The entry point of the user interface layer is a macro (4) named ‘index’, so named so that it is the default handler:

```
if (NoBlank(Locate(Xstudent, student_id:last_student) −| (answer:last_answer))) {
  Render! show_completed_answers;
  }
  else {
  Render! show_answer_form;
```

| | |
|---|---|
| } | (3) |

As before, the expression “Locate(Xstudent, student_id:last_student):” locates the cell containing the relevant student_id, in this case cell joe_id. The expression “joe_id -| (answer:last_answer):” indicates the rectangular region that covers the same row(s) as joe_id, and the same columns as the region ‘answer:last_answer’. In the present example, this expression evaluates to the cells that contain Joe's answers.

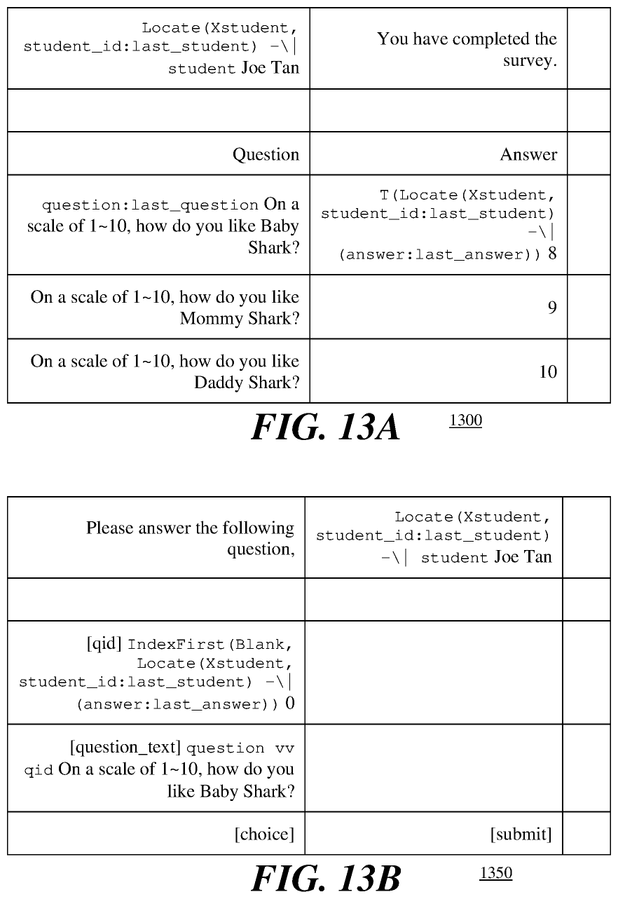

Referring to FIGS. 13A and 13B, diagrams 1300 and 1350 depict two options for the rendered spreadsheet after execution of the ‘index’ macro. If the rectangular region indicated by the expression “joe_id -| (answer:last_answer):” contains no blanks, then the spreadsheet “show_completed_answers” is rendered. The spreadsheet “show_completed_answers” is shown in the diagram 1300 where monospace text are the formulars typed into the cells. Note that if a formula evaluates to a region of cells, then the result will spill into neighboring cells on the right and to the bottom, as explained hereinabove.

Otherwise, if the rectangular region indicated by the expression “joe_id -| (answer:last_answer):” contains blanks, the spreadsheet “show_answer_form” is rendered. The spreadsheet “show_answer_form” is shown in the diagram 1350. The content of the “show_answer_form” spreadsheet solicits an answer for the first unanswered question given the student by presenting to the student “Please answer the following question”.

The style of choice is defined as “input”&“select”\\“options”&T(Range(1,10)), which evaluates as shown in Table 1 below:

TABLE 1

| input | select | | | | | | | | | |
|---|---|---|---|---|---|---|---|---|---|---|
| options | 1 | 2 | 3 | 4 | 5 | 6 | 7 | 8 | 9 | 10 |

This tells the HTML renderer to render the cell as a HTML selection box with the given choices. The style of submit is defined as:

| “input”&“submit”\\“target”&on_student_submt“\\”data“& | |
|---|---|
| (“qid”&qid\\“answer”&choice) | (4) |

Suppose the user has chosen 8, the style would evaluate as shown in Table 2:

TABLE 2

| input | submit | |
|---|---|---|
| target | on_student_submit | |
| data | qid | 0 |
| | answer | 8 |

Thus, when the submit button is clicked, the “on_student_submit” macro is executed by the spreadsheet engine in accordance with the submit (5) shown above and with the fields Xqid and Xanswer filled with the submitted value.

The lifetime of the survey website being rendered by the spreadsheet in accordance with the present embodiments occurs as follows. First, when a student has unanswered questions, we render the “show_answer_form” sheet to solicit an answer. Next, when an answer is submitted, the “on_student_submit” macro is invoked to update the data sheet. Then, when a student has answered all questions, the “show_completed_answers” spreadsheet is rendered to display all their answers. Thereafter, the teacher can perform any analysis on the answers submitted using usual spreadsheet formulars on the data collected in the data sheet.

In general, a dynamic web page can be rendered from a spreadsheet after substitutions as dictated by user submitted query parameters. When a URL is requested, the server may walk the path from the Root sheet in a spreadsheet document following the request URL. For example, in response to a request:

http://doc.abc.com.demo/ticket_manager/ticket?id=123 (5)

the server might look in the document root and find spreadsheet file demo/ticket_manager. It opens the file and locates the sheet at Root.ticket in accordance with the present embodiment. It does the substitution for Xid to 123 and renders the sheet Root.ticket into HTML. The substitution process is fundamentally the same as sheet substitutions in function calls, including the X prefix, except the whole substituted sheet is rendered as the result.

Constraints are a central concept in SQL databases. They are the key to enforcing data consistency. Experienced database administrators know that without constraints, eventually bad data will creep in. In accordance with the present embodiments, a user can designate certain cells and/or formulars as ‘constraints’, bringing constraints to spreadsheets. Such cells and formulars must evaluate to non-error, non-false values at all times. If an action (such as changing some cell's content) causes one or more of the constraints to fail, then the action is rejected and the spreadsheet document is restored to the state before the action was attempted. Note, in particular, that the action of designating a cell or a formular as a constraint is itself subject to this action check. Hence, if a cell is currently in an error state, then designating it as a constraint will fail.

Once constraints are defined, the data owner has assurance that these important invariants will be upheld. One example is to check that the ID column holds unique values such as in the constraint “AllUnique(#id)”. Here ‘#id’ refers to the id column, and ‘AllUnique( )’ evaluates to true if and only if its parameter (e.g., the id column) contains no duplicates.

Another example is to check that the sku cell refers to a Stock Keeping Unit (SKU) product code that actually exists, and is not “unknown” such as in expression (6) below:

Locate(sku, #all_skus)) && sku !=“unknown” (6)

where ‘#all_skus’ refers to the region holding all SKU product codes, and ‘Locate( )’ looks up the position of its first parameter in the region specified as its second parameter. An error is returned if the look up fails.

If invariants like expression (6) are violated, the business data can be rendered unusable. The assurance provided by defining constraints is particularly important for business applications, the primary use cases for spreadsheet users.

Under some circumstances, a constraint must be temporarily broken first, and then restored only after multiple user actions. For example, to correct a spelling in the sku cell in the previous example, the relevant spellings in ‘#all_skus’ and ‘sku’ must both be corrected, and the constraint is violated when only one has been corrected. Therefore, the user may temporarily disable a constraint. A disabled constraint is simply a non-constraint, with a visual reminder that it should be reinstated at some point.

Consider a common expression for looking up an ID in a column. In the context of the example of FIGS. 12A and 12B presented hereinabove, a common expression would be the expression (7) below:

Locate(Xstudent, student_id:last_student) (7)

A naive implementation would scan the table “student_id:last_student” sequentially for the value of “Xstudent”. This is commonly referred to as a linear scan in database literature and can be a resource expensive operation. To avoid this expensive operation, databases build indices to enable fast lookup. But database indices depend on a user to provide a predefined data schema, and to provide what indices to build over such schema. This is obviously not feasible for spreadsheets. For example, a user should be able to “Locate( )” any value in any region with efficiency. Therefore, in accordance with the present embodiments, a novel method of indexing cell values in spreadsheets using spatial indices to accelerate searching for a value in arbitrary blocks of cells in the spreadsheet(s) is proposed.

First, we define a total order of possible cell values. For example, we define arbitrarily that integers are smaller than floating points, which are in turn smaller than strings, which are in turn smaller than the blank value. Within each data type, the usual ordering applies. Subsequently, the state of a spreadsheet can be encoded as a three dimensional point cloud, where a value of z at cell row y column x is represented by a point at (x,y,z).

A query “Locate(value, start:end)” is thus a search in the three dimensional space to locate an intersection of a spreadsheet's point cloud and a cuboid bounded by:

Column(start)<=x<=Column(end), Row(start)<=y<=Row(end), and value <=z<=value (8)

Such a search can be sped up by a spatial index, the most well-known of which is the R-tree index. The following discussion will use an R-tree index, but it is understood that most other spatial indices can also be used in accordance with the present embodiments with little modification.

An R-tree recursively divides a point cloud C into two sets (C1 and C2) and records the bounding box of each set. The sets are chosen to be balanced, compact, and disjoint, as much as possible. Searching an R-tree is a trivial recursive function, and adding, removing, moving points in an R-tree is well known to those skilled in the art.

Some other expressions that can be sped up by the spatial index are:

MinString(start:end) and friends (9)

AllSame(start:end) can be sped up simply as Min(start:end)==Max(start:end) (10)

start:end<5 (11)

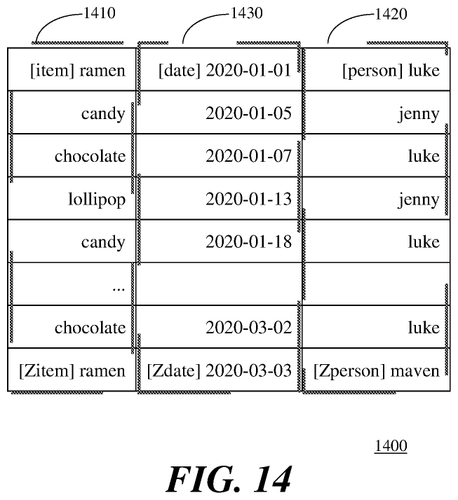

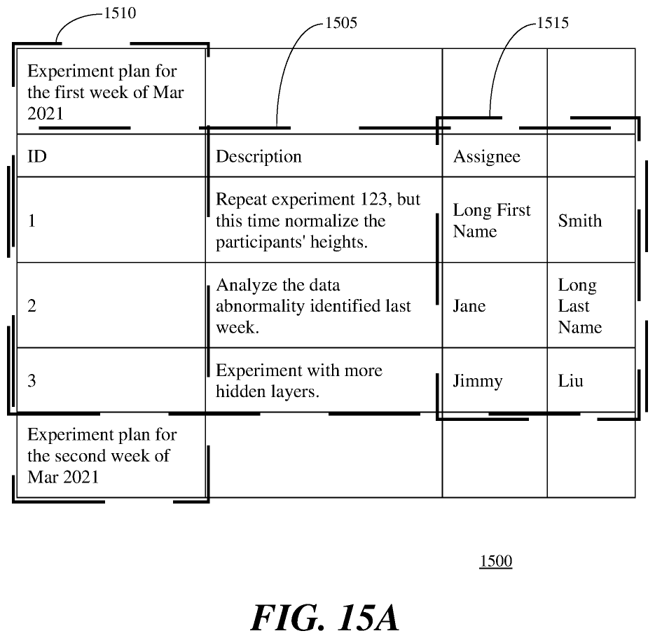

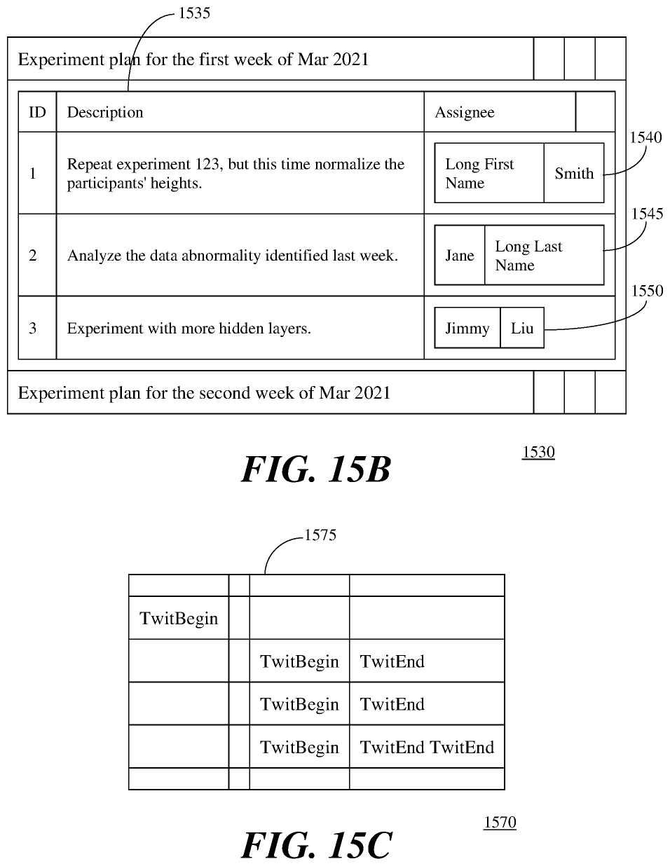

Special considerations are applicable for && queries. Referring to FIG. 14, a spreadsheet 1400 depicts a scenario of a long record of snacks 1410 purchased by children 1420 and the dates of purchase 1430. Queries on the spreadsheet can be accelerated by spatial indices in accordance with the present embodiments as discussed hereinabove. A query (12) returns the indices of the records with dates in a short range by one child:

Between(date:Zdate, ‘2020-01-20’, ‘2020-01-21’) && person:Zperson==“luke” (12)

The first subexpression is sparse, matching only a few records. However, the second subexpression is dense. In a naive strategy where both subexpressions are evaluated and then their union is found, much time will be wasted evaluating the boolean vector ‘person:Zperson==“luke”’, only to throw most of it away.

To remedy this, both constraints are considered simultaneously as the query is divided-and-conquered. At each step, the remaining search area is divided either according to the first subexpression or the second subexpression, and the subexpression with a higher information content is selected. Since the date is more discriminatory, it is more likely to choose to split the search area according to the date, thus quickly pruning away the sheet's point cloud.

Although spatial indices such as the generic R-tree index can be used to speed up many types of queries, others still benefit from specialized data structures. Let's consider a cell commonly used as a constraint: “ColSorted(a:b)”. The constraint evaluates to true if and only if every column in the range specified is sorted, that is each cell is no bigger than the cell below.

Sometimes we wish to define hierarchical regions in a spreadsheet. An example is a table-within-table (TWIT), a region in the spreadsheet whose row height and column width are determined independently of those of the larger spreadsheet's row height and column width as discussed hereinabove. Referring to FIGS. 15A, 15B and 15C, spreadsheets 1500 1530, 1570 depict use of TWITS in accordance with the present embodiments.

Presentation of a table 1505 in the spreadsheet 1500 can be improved in several ways. First, the ID column 1510 is too wide, as it is stretched by parts of the sheet outside the table. In addition, the assignee's name 1515 can be shown more compactly. In order to improve the presentation, the whole table 1505 can be rendered as a big TWIT 1535, and each row's first name and last name cells as small TWITs 1540, 1545, 1550 as shown in the spreadsheet 1530.

The straightforward way of defining the TWITs is to give each pair of begin/end cells a unique TWIT ID, so that the TWIT regions are explicitly identified. However, this can be cumbersome when we need to mass generate a (possibly unknown) number of TWITs, like the name TWITs.

Instead, the user is enabled in accordance with the present embodiments to define which cells are begin cells and end cells, and the system can automatically match the begin and end cells to form non-intersecting regions. In the example shown in the spreadsheet 1530, the user can input the following definitions:

‘ID: TwitBegin (13)

GoSE(‘ID): TwitEnd (14)

GrowS(‘Assignee vv 1): TwitBegin (15)

GrowS(‘Assignee [symbol] 1): TwitEnd (16)

The expression ‘ID locates the cell containing the string “ID”. “GrowS(a)” starts from the region containing just the cell a, and keeps extending the bottom down until the cells just below it are all blanks. Hence, “GrowS(‘Assignee vv 1)” starts from just below the cell containing the string “Assignee” and extends down till it encounters the first blank cell. Similarly, “GrowSE(a)” starts from the region containing the cell a and keeps extending the region to the right and to the bottom until it grows into a table that is bordered completely by blanks on the immediate right, to the immediate bottom, and to the immediate bottom-right. “GoSE(a)” is the bottom-right corner of “GrowSE(a)”. These are examples of label position expressions.

The definition (15) of “GrowS(‘Assignee vv 1): TwitBegin” marks every cell below the Assignee cell as a TwitBegin cell. The definition (16) of “GrowS(‘Assignee [symbol] 1): TwitEnd marks every cell in the last column below the Assignee cell as a TwitEnd. The result of the assignments of the definitions (13), (14), (15), and (16) is shown in the table 1575 of the table 1570 (FIG. 15C).

Further in accordance with the present embodiments, non-intersecting regions can be defined as regions that are either completely disjoint or a region that is completely contained within another so that their borders do not intersect. It can be shown that a set of start and end cells can admit at most one matching that corresponds to non-intersecting regions, and that such a matching can be found in “O(n log n)” time, where n is the number of start cells. Therefore, we can always recover the user's intended TWITs from these TwitBegin and TwitEnd tags.

Alternatively, some of the TwitBegin or TwitEnd tags can be augmented with IDs. A pair of TwitBegin and TwitEnd tags must each have the same ID. This lets the user explicitly state the pairing. However, with the automatic matching algorithm, such IDs do not need to be unique. Thus, hierarchical regions can be created in a flat 2D spreadsheet structure in accordance with the present embodiments by indicating which cells have begin tags and which cells have end tags, but without explicit and precise matching of begin cells and end cells, so accordingly the system picks unique pairings of begin tags and end tags that generate sets of non-intersecting regions.

When a sheet contains a large number of rows, inserting and removing rows can become extremely expensive, as it affects every row below it. Efficient insertion and removal of rows and columns is mitigated by the introduction of bignum row numbers to mitigate the problem. Bignums are numbers with an arbitrarily high precision so they can represent exactly all numbers that can be represented exactly in binary.

In accordance with the present embodiments, the row numbers are not necessarily consecutive, but can be fractional, and integers can be skipped. For example, starting with rows 1, 2, 3, 4, 5, and the user removes row 3 and inserts another row between 1 and 2, the row numbers are now 1, 1.5, 2, 4, 5. This way, removing a row is a cheap operation that doesn't unnecessarily affect the rows below it.

With bignum rows, although the order of two rows can still be determined, it is no longer trivial to determine the previous row or next row of a certain row. An index is needed to help answer the two queries: (i) What is the n-th row above or below a row r? and (ii) What is the distance between rows r1 and r2?

The index should allow one to efficiently answer such queries, but also the index should be broken down into small pieces of information, so that during the computation of a cell, recording of which pieces of information were used can be done. Then when some pieces of information change, one understands which cells to recompute. Also, when a row is inserted/removed, only a small number of such pieces of information change and the list of such pieces are easy to locate. Subsequently, ideally only those cells that truly require recomputation are recomputed.

For this purpose, a skip-list-like structure is used in accordance with the present embodiments. Specifically, when a new row is created, it is randomly assigned a level. A row has a probability of 0.5 of being in level 1, 0.25 of being in level 2, etc. The level of a row number never changes. Also, each level 1 node records the next level 1 node; each level 2 node records the next level 1 node and the next level 2 node. Further, in general a level N node records N next nodes from level 1 to level N. Finally, a special, invisible, top row is assigned row number ‘-inf’ and is considered to be in all levels.

Thus, level 1 forms a linked list of all rows. Higher levels are express lanes, allowing the search to proceed faster over larger spans. With this index in place, a question like “What is the n-th row above/below a row r?” can be answered using “O(log(N))” pieces of information. In addition, a question like “What is the distance between rows r1 and r2?” can be answered using “O(log(N))” pieces of information.

Thus, it can be seen that, in accordance with the present embodiments, when a row is inserted or removed, it affects at most 2 links in each level. Therefore, the insertion or deletion of the row disrupts at most“O(number of levels)” pieces of information.

For presentation to the user, we may choose not to show the bignum row numbers may not be shown directly, but rather the distance to the first row is shown so that the users will still see consecutive integers. As explained hereinabove, the distance between two rows can be efficiently computed using the skip list.

Thus, it can be seen that the present embodiments provide a robust user-facing spreadsheet programming language which enhances utilization and operation of spreadsheets. In accordance with present embodiments, spills, sheet substitution as function calls, sheet substitution (thunks) as cell values and callback parameters, barriers, programmatic style definitions, TWITs, classes, label position expressions, sheet substitution (thunks) as remote callbacks, fine-grained permissions in collaborative documents, web pages using sheet substitution, dynamic web pages defined by a single spreadsheet, user-designated constraints, spatial indices, persistent indices and delta update cells, bignum row and column numbers, and row and column indices have been defined to provide an easy, flexible and versatile backward-compatible spreadsheet-friendly solution.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

What is claimed is:

1. A method for spreadsheet programming comprising:
assigning labels to cells of a spreadsheet, each of the labels assigned to one of a plurality of adjoining variable value cells for data corresponding to a plurality of values of a variable, wherein the plurality of adjoining variable value cells is user defined by a pair of labels indicating a start and an end of a cell range of the plurality of adjoining variable value cells; and
defining a spill area into which data can flow from a cell having an expression defined therein in response to the expression including a variable range defined by the plurality of values of the variable, the spill area automatically sized to a plurality of expression solutions corresponding to the plurality of values of the variable.

2. The method in accordance with claim 1 wherein defining a spill area comprises defining a non-shrinking spill area into which data can flow from a cell having an expression defined therein before subsequent user input of data into the plurality of adjoining variable value cells.

3. The method in accordance with claim 1 further comprising defining a barrier across one or more cells to establish an elastic limit to the spill area, and wherein defining the spill area comprises defining cells in an elastic spill area without disturbing a rest of the spreadsheet adjoining the barrier when data entered into the plurality of adjoining variable value cells corresponds to a plurality of expression solutions greater than a number of the cells within the spill area.

4. The method in accordance with claim 3 wherein defining a barrier across one more cells comprises defining a barrier across all the cells of a row or a column of the spreadsheet.

5. The method in accordance with any of the preceding claims further comprising defining one or more tables-within-table (TWITs) circumscribing one or more mini-tables inside a larger table of the spreadsheet, wherein a number of rows, a number of columns and a total area occupied by each of the one or more mini-tables are defined in response to a user TWIT input.

6. The method in accordance with claim 5 wherein the mini-tables inside the larger table of the spreadsheet comprise at least two non-intersecting regions.

7. The method in accordance with claim 5 or claim 6 wherein the user TWIT input comprises designating one or more cells as TWIT begin cells and one or more cells as TWIT end cell, and wherein defining the TWITs to circumscribe the mini-tables inside the larger table of the spreadsheet comprises defining the rows, the columns and the total area occupied by each of the one or more mini-tables in response to the one or more TWIT begin cells and the one or more TWIT end cells.

8. The method in accordance with claim 6 wherein at least one of the one or more TWIT begin cells and a corresponding at least one of the one or more TWIT end cells comprise a TWIT pairing ID.

9. The method in accordance with claim 7 or claim 8 wherein an ambiguity is defined by an absence of the TWIT pairing ID or by two of the one or more TWIT begin cells comprising a same TWIT pairing ID or by two of the one of more TWIT end cells comprising a same TWIT pairing ID, the method further comprising resolving the ambiguity by disallowing intersection of TWIT borders.

10. The method in accordance with any of the preceding claims comprising displaying cells of the spreadsheet in accordance with user programmable two-dimensional style definitions.

11. The method in accordance with claim 10 wherein the user programmable two-dimensional style definitions comprise one or more of data font style, data font color, and cell background color.

12. A method for spreadsheet programming comprising substituting another item into a spreadsheet in response to cell values of a cell in the spreadsheet comprising a function call and/or a remote callback.

13. The method of claim 12 wherein an error is generated if a shape of the item substituted into the spreadsheet does not match a shape of an original value of the cell.

14. The method of claim 12 wherein substituting another item into the spreadsheet comprises substituting a dynamically specified spreadsheet reference into the spreadsheet in response to cell values of a cell in the spreadsheet, wherein the dynamically specified spreadsheet reference comprises a dynamically specified directory reference and a spreadsheet name of another spreadsheet.

15. The method in accordance with any of the preceding claims wherein access to read and/or write code in cells of the spreadsheet is controlled in accordance with fine-grained access control permissions, wherein the fine-grained access control permissions comprise sheet-owners and sheet-users defined in accordance with one or more of concrete users and abstract users.

16. The method in accordance with any of the preceding claims further comprising defining a label position expression for operating on the labels wherein the label position expression operates on coordinates of the cells to which the labels are assigned.

17. A spreadsheet comprising:
a plurality of cells arranged in a two-dimensional array, one or more of the plurality of cells comprising cell values for substituting another item into the spreadsheet, wherein the cell values comprise a function call and/or a remote callback.

18. The spreadsheet in accordance with claim 17 wherein a dynamically specified spreadsheet reference is substituted into the spreadsheet in response to the cell values, and wherein the dynamically specified spreadsheet reference comprises a dynamically specified directory reference and a spreadsheet name.

19. A spreadsheet comprising:
a plurality of cells arranged in a two-dimensional array, wherein the plurality of cells comprise a plurality of adjoining variable value cells for data corresponding to a plurality of values of a variable, and wherein the plurality of adjoining variable value cells are user defined by a pair of cell values indicating a start and an end of a cell range of the plurality of adjoining variable value cells, and
wherein the plurality of cells further comprises a spill area into which data can flow from a cell having an expression defined therein in response to the expression including a variable range defined by the plurality of values of the variable, the spill area automatically sized to a plurality of expression solutions corresponding to the plurality of values of the variable.

20. The spreadsheet in accordance with claim 19 wherein the spill area comprises a non-shrinking spill area into which data can flow from a cell having an expression defined therein before subsequent user input of data into the plurality of adjoining variable value cells.

21. The spreadsheet in accordance with claim 19 wherein a barrier is defined across one or more cells to establish an elastic limit to the spill area, and wherein the spill area comprises cells defined to be in an elastic spill area without disturbing a rest of the spreadsheet adjoining the barrier when data entered into the plurality of adjoining variable value cells corresponds to a plurality of expression solutions greater than a number of the cells within the spill area.

22. The spreadsheet in accordance with claim 21 wherein the barrier is defined across all the cells of a row or all the cells of a column of the spreadsheet

23. The spreadsheet in accordance with any of claims 17 to 22 wherein access to read and/or write code in cells of the spreadsheet is controlled in accordance with fine-grained recess control permissions, wherein the fine-grained access control permissions comprise sheet-owners and sheet-users defined in accordance with one or more of concrete users and abstract users.

24. The spreadsheet in accordance with any of claims 17 to 23 wherein the plurality of cells comprise a first table-within-table (TWIT) circumscribing a first mini-table inside a larger table of the spreadsheet, and wherein a number of rows, a number of columns and a total area occupied by the first mini-table are defined in response to a user TWIT input.

25. The spreadsheet in accordance with claim 24 wherein the plurality of cells comprise a second TWIT circumscribing a second mini-table inside the larger table of the spreadsheet, and wherein the first mini-table and the second mini-table comprise non-intersecting regions within the larger table of the spreadsheet.

26. The spreadsheet in accordance with claim 24 or claim 25 wherein the user TWIT input comprises a begin cell definition designating on or more cells as TWIT begin cells and an end cell definition designating one or more cells as TWIT end cells to define the rows and the columns occupied by the first mini-table.

27. The spreadsheet in accordance with claim 26 wherein at least one of the TWIT begin cells and at least one of the TWIT end cells comprise a TWIT pairing ID.

28. The spreadsheet in accordance with claim 27 wherein an ambiguity is defined by an absence of the TWIT pairing ID or by two of the one or more TWIT begin cells comprising a same TWIT pairing ID or by two of the one of more TWIT end cells comprising a same TWIT pairing ID, and wherein the method is automatically resolved by disallowing intersection of TWIT borders.

29. The spreadsheet in accordance with any of claims 17 to 28 wherein one or more of the plurality of cells include one or more user programmable two-dimensional style definitions for displaying the cell.

30. The spreadsheet in accordance with claim 29, wherein the user programmable two-dimensional style definitions comprise one or more of data font style, data font color, and cell background color.

31. The spreadsheet in accordance with any of claims 19 to 30 wherein one or more of the cells of the plurality of adjoining variable value cells are user defined by a label assigned thereto, and wherein a label position expression operates on the label in response to coordinates of the one or more of the cells of the plurality of adjoining variable value cells within the two-dimensional array.

32. A method for presentation of a dynamic website comprising:
generating the presentation of the dynamic website in response to a single spreadsheet document, the single spreadsheet document including data and business logic and the presentation of the dynamic website method generated in response to the data and the business logic of the single spreadsheet document.

33. The method in accordance with claim 32 wherein the business logic comprises one or more macros executed in response to user submitted data.

34. The method in accordance with claim 32 or claim 33 wherein generating the presentation of the dynamic website comprises:
substituting dynamic webpage request query parameters into a spreadsheet in response to a dynamic webpage request, and
rendering the spreadsheet as a webpage of the dynamic website in response thereto.

35. A spreadsheet comprising:
a plurality of cells arranged in a two-dimensional array, wherein one or more of the plurality cells comprise user-designated constraints designed to evaluate to non-error and non-false values.

36. The spreadsheet in accordance with claim 35, wherein an action performed on at least one of the one or more of the plurality cells is rejected in response to the action causing one or more of the user-designated constraints to fail, and wherein the spreadsheet restores to a state before the action was performed in response to the action causing the one or more of the user-designated constraints to fail.

37. A method for spreadsheet programming of a spreadsheet comprising:
user-designating one or more cells of the spreadsheet to include constraints designed to evaluate to non-error and non-false values;
performing an action on at least one of the one or more cells of the spreadsheet;
rejecting the action in response to the action causing at least one of the constraints to fail; and
restoring the spreadsheet to a state before the action was performed in response to the action causing the at least one of the constraints to fail.

38. A method to accelerate searching for a value in arbitrary blocks of cells of a spreadsheet, the method comprising:
utilizing a spatial index; and
defining a total order of possible cell values.

39. The method in accordance with claim 38 wherein the spatial index comprises an R-tree index.

40. A spreadsheet comprising:
a plurality of cells arranged in a two-dimensional array defined by a plurality of rows and a plurality of columns, wherein each of the plurality of rows is identified by a bignum row number, and wherein each of the plurality of columns is identified by a bignum column number, and wherein each bignum row number and each bignum column number comprise a number capable of arbitrarily high finite precision in its binary representation.

41. The spreadsheet in accordance with claim 40 further comprising a row skip-list for enabling efficient recomputation of cells in the plurality of cells when a row is added or removed from the plurality of rows.

42. The spreadsheet in accordance with claim 40 or claim 41 further comprising a column skip-list for enabling efficient recomputation of cells in the plurality of cells when a column is added or removed from the plurality of columns.
